(19) United States
(12) Patent Application Publication
(10) Pub. No.: US 2022/0393151 A1
(43) Pub. Date: Dec. 8, 2022

(54) ANODE ACTIVE MATERIAL, AND ANODE AND SECONDARY BATTERY COMPRISING SAME ANODE ACTIVE MATERIAL

(71) Applicant: LG ENERGY SOLUTION, LTD., Seoul (KR)

(72) Inventors: Keiko MATSUBARA, Tokyo (JP); Akira TAKAMUKU, Tokyo (JP)

(73) Assignee: LG ENERGY SOLUTION, LTD., Seoul (KR)

(21) Appl. No.: 17/774,280

(22) PCT Filed: Dec. 24, 2020
(86) PCT No.: PCT/KR2020/019161

§ 371 Date: May 4, 2022

(30) Foreign Application Priority Data
Dec. 25, 2019 (JP) 2019-235038

(51) Int. Cl. H01M 4/36; H01M 10/0525; H01M 4/485; H01M 4/62; H01M 4/131

(52) U.S. Cl. CPC H01M 4/364; H01M 10/0525; H01M 4/485; H01M 4/625; H01M 4/131; H01M 2004/027

(57) ABSTRACT

A negative electrode active material for a secondary battery for achieving high initial efficiency and improved discharge capacity and capacity retention. The negative electrode active material for a secondary battery includes first silicon oxide powder particles doped with at least one of alkali metal or alkaline earth metal, and second silicon oxide powder particles, which are not doped, wherein the second silicon oxide powder particles are amorphous. A negative electrode and a secondary battery including the negative electrode active material are also disclosed.

### TECHNICAL FIELD

The present application claims priority to Japanese Patent Application No. 2019-235038 filed on Dec. 25, 2019 with the Japan Patent Office, the disclosure of which is incorporated herein by reference. Embodiments of the present disclosure relate to a negative electrode active material, a negative electrode and a secondary battery.

### BACKGROUND ART

With the technology development and the increasing demand for mobile devices, the demand for secondary batteries as an energy source is dramatically increasing. Among secondary batteries, lithium ion secondary batteries having high energy density and voltage, a long cycle life and a low self-discharge rate are commercialized and widely used. Currently, many studies are being made with an attempt to achieve higher capacity of lithium ion secondary batteries.

A silicon-based material such as a silicon alloy or silicon oxide has higher theoretical capacity density than a carbon-based material such as graphite commonly used now, so there is a high expectation for the silicon-based material as a negative electrode material for improving the energy density of lithium ion secondary batteries. For example, SiOₓ shows the discharge capacity of 1700 mAh/g or more at the initial discharge, and it is about five times larger than that of graphite.

However, when the silicon-based material such as SiOₓ is used as a negative electrode active material, the initial efficiency (i.e., a ratio of discharge capacity to charge capacity at the first cycle charge/discharge) of a battery is lower than the initial efficiency when graphite is used. In regard to this problem, it is known that when silicon oxide powder pre-doped with Li or Mg is used as the negative electrode active material, the initial efficiency improves. However, when pre-doping is performed, in some instance, the discharge capacity reduces or the cycle characteristics degrade.

### RELATED LITERATURES

### Patent Literatures

Patent Literature 1: Japanese Patent Publication No. 2013-114820

Patent Literature 2: WO2015/059859

Patent Literature 3: Japanese Patent Publication No. 2017-188319

Patent Literature 4: Japanese Patent Publication No. 2012-33317

### DISCLOSURE

### Technical Problem

The present disclosure is directed to providing a negative electrode active material for a secondary battery for achieving high initial efficiency and improved discharge capacity and capacity retention, a negative electrode and a secondary battery.

### Technical Solution

According to an embodiment of the present disclosure, there is provided a negative electrode active material for a secondary battery comprising a first silicon oxide powder doped with at least one of alkali metal or alkaline earth metal, and an undoped second silicon oxide powder, wherein the second silicon oxide powder is amorphous.

In the negative electrode active material according to the above-described embodiment, an average particle size of particles that make up the first silicon oxide powder may be larger than an average particle size of particles that make up the second silicon oxide powder.

In the negative electrode active material according to the above-described embodiment, the average particle size of particles that make up the first silicon oxide powder may be 3 μm or more and 15 μm or less. Additionally, the average particle size of particles that make up the second silicon oxide powder may be 0.5 μm or more and 2 μm or less.

In the negative electrode active material according to the above-described embodiment, a weight ratio of the second silicon oxide powder to the first silicon oxide powder may be equal to or higher than 0.2.

In the negative electrode active material according to the above-described embodiment, a weight ratio of the second silicon oxide powder to the first silicon oxide powder may be less than 10.

In the negative electrode active material according to the above-described embodiment, the first silicon oxide powder may comprise microcrystals of silicon having a crystallite size of 5 nm or more and 30 nm or less.

In the negative electrode active material according to the above-described embodiment, the first silicon oxide powder may comprise at least one of Li₂SiO₃, Li₂Si₂O₅, Li₄SiO₄ or Mg₂SiO₄.

The negative electrode active material according to the above-described embodiment may further comprise a carbon material powder comprising at least one of natural graphite, artificial graphite, a graphitized carbon fiber or amorphous carbon. According to another embodiment of the present disclosure, there is provided a negative electrode for a secondary battery comprising a negative electrode active material layer formed on a negative electrode current collector, the negative electrode active material layer comprising the negative electrode active material according to the above-described embodiment. According to another embodiment of the present disclosure, there is provided a secondary battery comprising the negative electrode according to the above-described embodiment.

### BRIEF DESCRIPTION OF THE DRAWINGS

FIG. 1 is a diagram plotting the initial capacity, the initial efficiency and the capacity retention as a function of a weight ratio of first silicon oxide powder A and second silicon oxide powder B in example 1, example 2, comparative example 1 and comparative example 2.

FIG. 2 is a diagram plotting the initial capacity, the initial efficiency and the capacity retention as a function of a weight ratio of first silicon oxide powder A and second silicon oxide powder B in example 3, comparative example 3 and comparative example 4.

### DETAILED DESCRIPTION

Hereinafter, the embodiments of the present disclosure will be described. However, the present disclosure is not limited thereto.

In the specification, ‘average particle size’ refers to a particle size at 50% accumulated value in a particle size distribution measured by laser diffraction scattering, i.e., a median diameter D₅₀. Additionally, in the specification, ‘silicon oxide powder’ refers to powder comprising silicon oxide (may comprise any other element than silicon and oxygen) in which the total content of silicon and oxygen is 80 weight % or more. Additionally, in the specification, the sign ‘˜’ is used to cover the two extremes of the range indicated by the corresponding statement. For example, ‘1˜2’ refers to ‘1 or more and 2 or less’.

For higher capacity of lithium ion secondary batteries, when a silicon-based material such as SiOₓ is used as a negative electrode active material, the initial efficiency tends to be lower than the initial efficiency when graphite is used. The reason is presumed as follows. SiOₓ may form a reversible component capable of Li delithiation over cycles such as a Li—Si alloy, as well as an irreversible component incapable of Li delithiation over cycles such as lithium silicate in primary phase or secondary phase or higher during the first cycle charge. The lithium silicate suppresses the expansion of the silicon component in the negative electrode active material, but such an irreversible component does not contribute to the charge/discharge, resulting in lower initial efficiency. Accordingly, the initial efficiency of SiOₓ is about 65% to 70% and it is very low compared to the initial efficiency (about 90% to 95%) of graphite. By this reason, when SiOₓ alone is used as the negative electrode active material, an imbalance between the negative electrode active material and the positive electrode active material occurs and the positive electrode active material is wasted, resulting in reduced energy density.

Meanwhile, when the silicon-based material such as SiOₓ is pre-doped with Li or Mg, with the increasing pre-doping quantity, the initial efficiency improves, but compared to when pre-doping is not performed, discharge capacity reduction or cycle characteristics degradation may occur. The reason is presumed as follows. When pre-doping is performed, in some instances, in addition to an irreversible component formed when SiOₓ is not doped, in some instances, a silicon compound such as complex lithium silicate phase is formed, or a surplus lithium compound is formed the surface of the negative electrode active material particle. Accordingly, the discharge capacity per weight may be much lower than that of undoped SiOₓ. Additionally, presumably, the crystallinity of Si microcrystals in SiOₓ increases during doping, and as charging/discharging is repeated, cracking occurs on the surface of the particle or inside the particle or a material expansion rate increases, causing cycle degradation.

The inventors found that it is possible to achieve high initial efficiency and improved discharge capacity together by using a mixture of first silicon oxide powder pre-doped with alkali metal or alkaline earth metal and undoped second silicon oxide powder as the negative electrode active material. Additionally, the inventors found that the cycle characteristics are improved beyond expectation by mixing the first silicon oxide powder and the second silicon oxide powder. Additionally, the inventors found that the initial efficiency is improved beyond expectation by adding a carbon material to the first silicon oxide powder and the second silicon oxide powder.

[Nonaqueous Electrolyte Secondary Battery]

An embodiment of the present disclosure relates to the nonaqueous electrolyte secondary battery. The nonaqueous electrolyte secondary battery according to this embodiment comprises a negative electrode, a positive electrode and a separator and a nonaqueous electrolyte interposed between the negative electrode and the positive electrode. Specific examples of the secondary battery may include a lithium ion secondary battery having high energy density, discharge voltage and output stability advantages.

Hereinafter, description is briefly made taking the lithium ion secondary battery as an example, but the present disclosure is not limited to the lithium ion secondary battery and may be applied to a variety of nonaqueous electrolyte secondary batteries.

The lithium ion secondary battery according to an embodiment of the present disclosure comprises a negative electrode, a positive electrode and a separator and a nonaqueous electrolyte interposed between the negative electrode and the positive electrode. Additionally, the lithium ion secondary battery may optionally comprise a battery case to receive an electrode assembly comprising the negative electrode, the positive electrode and the separator, and a sealing member to seal the battery case.

[Negative Electrode]

The negative electrode comprises a negative electrode current collector and a negative electrode active material layer formed on one or two surfaces of the negative electrode current collector. The negative electrode active material layer may be formed on part or the entirety of the surface of the negative electrode current collector.

(Negative Electrode Current Collector)

The negative electrode current collector used in the negative electrode includes, without limitation, any type of negative electrode current collector that has conductivity while not causing a chemical change to the battery. For example, the negative electrode current collector may include copper; stainless steel; aluminum; nickel; titanium; sintered carbon; copper or stainless steel treated with carbon, nickel, titanium and silver on the surface; an aluminum-cadmium alloy.

The negative electrode current collector may be 3 μm or more and 500 μm or less in thickness. The negative electrode current collector may have fine texture on the surface to improve the adhesion with the negative electrode active material. The negative electrode current collector may have various shapes, for example, a film, a sheet, a foil, a net, a porous body, a foam and a nonwoven fabric.

(Negative Electrode Active Material Layer)

The negative electrode active material layer may be formed by, for example, coating a negative electrode active material slurry prepared by dissolving or dispersing a mixture of a negative electrode active material, a binder and a conductive agent in a solvent on the negative electrode current collector, drying and roll pressing, or may be formed by casting the negative electrode active material slurry on a support and laminating a film separated from the support on the negative electrode current collector. The mixture may further comprise a dispersing agent, a filler or any other additive if necessary.

The negative electrode active material may be included in an amount of 80 weight % or more and 99 weight % or less based on the total weight of the negative electrode active material layer.

(Negative Electrode Active Material)

In the lithium ion secondary battery according to an embodiment, the negative electrode active material may comprise first silicon oxide powder A doped with at least one of alkali metal or alkaline earth metal and undoped second silicon oxide powder B. Additionally, the negative electrode active material may further comprise carbon material powder.

The first silicon oxide powder A is a result of doping silicon oxide powder with at least one of alkali metal or alkaline earth metal. That is, particles that make up the first silicon oxide powder A may comprise at least one of doped alkali metal element or alkaline earth metal element. The first silicon oxide powder A may comprise, for example, silicon oxide SiOₓ (0<x<2), single element silicon Si, a single element of doped metal element, a silicate of doped metal, any other silicon compound or a compound of doped metal.

The silicon oxide powder used as a raw material before doping may be, for example, a powder of SiOₓ. SiOₓ may have a structure, for example, in which Si microcrystals are dispersed within an amorphous silicon oxide matrix in the microcrystalline or amorphous form. A ratio x of oxygen to silicon is 0<x<2, preferably 0.5<x<1.6, and more preferably 0.8<x<1.5. For example, the silicon oxide powder as the raw material may be SiO (x=1). Additionally, the silicon oxide powder as the raw material may consist of SiOₓ having a specific x value, and may comprise a mixture of different types of SiOₓ powder having different x values.

The silicon oxide powder as the raw material may be an amorphous structure not having a crystalline phase except the microcrystals of silicon dispersed in the structure. The dispersed microcrystals are so small that they do not appear as a diffraction peak in an X-ray diffraction (XRD) pattern, and the XRD pattern of the silicon oxide powder as the raw material does not substantially have a crystalline phase derived diffraction peak. In the specification, even a material comprising microcrystals is said to be ‘amorphous’ when a diffraction peak is not found in the XRD pattern. Meanwhile, the XRD pattern of the silicon oxide powder as the raw material may have a diffraction peak derived from the dispersed microcrystals.

The metal element used for doping includes any alkali metal or alkaline earth metal without limitation. For example, at least one of lithium, sodium, potassium, magnesium or calcium may be used for doping of the silicon oxide powder as the raw material, but is not limited thereto.

For example, when lithium is used for doping, the first silicon oxide powder A may comprise microcrystals of silicon or lithium silicate in the structure. For example, the first silicon oxide powder A may have a structure in which silicon or lithium silicate is dispersed within an amorphous silicon oxide matrix in a microcrystalline or amorphous form. Examples of the lithium silicate may include Li₂SiO₃, Li₂Si₂O₅ and Li₄SiO₄, but are not limited thereto. In addition to the foregoing, there may be any other component, for example, a lithium-based material, a silicon-based material, a lithium silicon compound, etc.

Likewise, for example, when magnesium is used for doping, the first silicon oxide powder A may have a structure in which microcystals of silicon or magnesium silicate (MgSiO₃ or Mg₂SiO₄) are dispersed in an amorphous silicon oxide matrix. Additionally, when calcium is used for doping, the first silicon oxide powder A may have a structure in which microcrystals of silicon or calcium silicate (CaSiO₃ or Ca₂SiO₄) are dispersed in an amorphous silicon oxide matrix. The same is the case with any other alkali metal or alkaline earth metal used for doping.

The total doping quantity of alkali metal or alkaline earth metal in the first silicon oxide powder A may be, for example, 0.1 weight % or more and 20 weight % or less, preferably 0.5 weight % or more and 15 weight % or less, and more preferably 1 weight % or more and 10 weight % or less based on the total of the first silicon oxide powder A.

The XRD pattern of the first silicon oxide powder A may have at least one diffraction peak derived from the microcrystals in the silicon oxide matrix. Meanwhile, even when a diffraction peak is not observed in the XRD pattern of the silicon oxide powder as the raw material, doping may cause crystallization or produce a new crystal phase, and in turn, a diffraction peak may appear in the XRD pattern of the first silicon oxide powder A.

In the first silicon oxide powder A, the size of the silicon microcrystal in the silicon oxide matrix (hereinafter, the size of a single microcrystal is referred to as ‘crystallite size’. In the specification, ‘crystallite size’ indicates a value of D calculated using the following Scherrer formula (1)) may be, for example, 5 nm or more and 30 nm or less, preferably 5 nm or more and 20 nm or less, and more preferably 5 nm or more and lOnm or less. The crystallite size of the microcrystal may be calculated using the following Scherrer formula (1) well known in the art from the line width of each microcrystal derived peak on the XRD pattern of the first silicon oxide powder A.

D(nm)=Kλ/B cos θ (1)

Here, D is the crystallite size of the microcrystal, B is the full width at half maximum (rad) of a target peak of the XRD pattern, θ is the diffraction angle of the XRD pattern, K=0.9, k=0.154 nm (in the case of CuKα).

For example, in the case of silicon, a diffraction peak of the (111) plane is observed near 2θ=28.4°, and the crystallite size D of the silicon microcrystal in the first silicon oxide powder A may be estimated from the full width at half maximum and the diffraction angle θ of the (111) peak.

The average particle size of particles that make up the first silicon oxide powder A used in the negative electrode active material may be, for example, 1 μm or more and 20 μm or less, preferably 3 μm or more and 15 μm or less, and more preferably 4 μm or more and 10 μm or less.

The use of the negative electrode active material comprising the first silicon oxide powder A may improve the initial efficiency compared to the negative electrode active material comprising undoped silicon oxide powder alone. Presumably, in undoped silicon oxide powder, an irreversible component that does not contribute to the charge/discharge, such as a silicate phase, is produced in the first charge/discharge cycle, but in contrast, the first silicon oxide powder A already comprises a silicate phase, and thus may suppress a reduction in the first cycle discharge capacity compared to the first cycle charge capacity to some extent.

The second silicon oxide powder B is a powder of undoped silicon oxide. Here, ‘undoped’ refers to undoping with a metal element and a nonmetal element other than silicon and oxygen except an unavoidable impurity. That is, particles that make up the second silicon oxide powder B may not comprise a metal element and a nonmetal element other than silicon and oxygen except an unavoidable impurity. For example, the second silicon oxide powder B is a powder of SiOₓ. For example, SiOₓ may have a structure in which Si microcrystals are dispersed within an amorphous silicon oxide matrix in a microcrystal or amorphous form. A ratio x of oxygen to silicon is 0<x<2, preferably 0.5≤x≤1.6, and more preferably 0.8≤x≤1.5. For example, the second silicon oxide powder B may be SiO(x=1). Additionally, the second silicon oxide powder B may consist of SiOₓ having a specific x value, and may comprise a mixture of at least two types of SiOₓ powder having different x values.

The second silicon oxide powder B may be an amorphous structure having no crystalline phase except microcrystals of silicon dispersed in the structure. For example, the XRD pattern of the second silicon oxide powder B may not substantially have a crystalline phase derived diffraction peak when the dispersed microcrystals are so small that they do not appear as a diffraction peak in the XRD pattern.

For example, the average particle size of particles that make up the second silicon oxide powder B used in the negative electrode active material may be smaller than the average particle size of particles that make up the first silicon oxide powder A. The average particle size of particles that make up that the second silicon oxide powder B may be, for example, 0.1 μm or more and 5 μm or less, preferably 0.3 μm or more and 3 μm or less, and more preferably 0.5 μm or more and 2 μm or less.

The use of the negative electrode active material comprising the second silicon oxide powder B may improve the discharge capacity or cycle characteristics, compared to the negative electrode active material consisting of silicon oxide powder doped with alkali metal or alkaline earth metal. Presumably, the diffusion of metal ions in the microcrystals of SiOₓ included in the second silicon oxide powder B is faster than the doped silicon oxide, but SiOₓ included in the second silicon oxide powder B is amorphous, and thus may suppress cracking or expansion/contraction caused by the charge/discharge compared to the doped silicon oxide having high crystallinity. However, this mechanism is simply an exemplary presumption, and does not limit the present disclosure.

The weight ratio A:B of the first silicon oxide powder A and the second silicon oxide powder B in the negative electrode active material may be, for example, 1:9 to 9:1, preferably 3:7 to 9:1, more preferably 4:6 to 9:1, and most preferably 5:5 to 8:2. When the weight ratio is represented as B/A, the weight ratio B/A may be, for example, 0.1 or more, preferably 0.2 or more, and more preferably 0.25 or more. Additionally, the weight ratio B/A may be, for example, less than 10, preferably less than 5, and more preferably less than 2. When the weight ratio is within the above-described range, it is possible to achieve high initial efficiency and improved discharge capacity and cycle characteristics.

When the negative electrode active material comprises the carbon material powder, the carbon material powder may comprise any type of carbon material commonly used in negative electrode active materials of nonaqueous electrolyte secondary batteries. For example, the carbon material powder may comprise at least one of natural graphite, artificial graphite, graphitized carbon fiber or amorphous carbon, but is not limited thereto. Complexes with any other elements than carbon may be used. Meanwhile, the carbon material may include any one of low crystallinity carbon or high crystallinity carbon. The low crystallinity carbon typically includes soft carbon and hard carbon, and the high crystallinity carbon typically includes amorphous, platy, scaly, spherical or fibrous high temperature sintered carbon such as natural graphite or artificial graphite, Kish graphite, pyrolytic carbon, mesophase pitch-based carbon fibers, mesocarbon microbeads, mesophase pitch, and coal and petroleum coke.

The average particle size of particles that make up the carbon material powder may be, for example, 1 μm or more and 50 μm or less, and preferably 10 μm or more and 20 μm or less.

When the negative electrode active material comprises the first silicon oxide powder A and the second silicon oxide powder B and further comprises the carbon material powder, a weight ratio of the silicon material (i.e., the first silicon oxide powder A and the second silicon oxide powder B) and the carbon material in the negative electrode active material may be, for example, 1:99 to 50:50, preferably 5:95 to 30:80, and more preferably 8:92 to 20:80.

When the negative electrode active material comprises the carbon material powder, the carbon material tends to exhibit better initial efficiency and cycle characteristics than the silicon material, and thus it is possible to obtain the improved initial efficiency and cycle characteristics, compared to the negative electrode active material consisting of the first silicon oxide powder A and the second silicon oxide powder B.

Meanwhile, in addition to the first silicon oxide powder A, the second silicon oxide powder B and the carbon material powder, the negative electrode active material may further comprise any other material.

(Binder)

The binder is added to promote the bonding between the active material and the conductive agent or between the active material and the current collector. Examples of the binder may include at least one of polyvinylidene fluoride (PVdF), polyvinylalcohol (PVA), polyacrylonitrile, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene polymer (EPDM), sulfonated EPDM, styrene butadiene rubber (SBR), poly acrylate, acrylamide, polyimide, fluorine rubber or copolymers thereof, but are not limited thereto.

The binder content may be 0.1 weight % or more and 30 weight % or less based on the total weight of the negative electrode active material layer. The binder content may be preferably 0.5 weight % or more and 20 weight % or less, and more preferably 1 weight % or more and 10 weight % or less. When the binder content satisfies the above-described range, it is possible to prevent degradation of the capacity characteristics of the battery and impart sufficient adhesive strength in the electrode.

(Conductive Agent)

The conductive agent includes, without limitation, any type of electrically conductive material that does not cause a chemical change. Examples of the conductive agent may include at least one of a carbon-based material such as artificial graphite, natural graphite, carbon nanotubes, graphene, carbon black, acetylene black, ketjen black, denka black, thermal black, channel black, furnace black, lamp black, a carbon fiber; metal powder or a metal fiber of aluminum, tin, bismuth, silicon, antimony, nickel, copper, titanium, vanadium, chrome, manganese, iron, cobalt, zinc, molybdenum, tungsten, silver, gold, lanthanum, ruthenium, platinum, iridium; conductive whiskers of zinc oxide, potassium titanate; conductive metal oxide such as titanium oxide; or conductive polymer such as polyaniline, polythiophene, polyacetylene, polypyrrole, polyphenylene derivatives, but are not limited thereto.

The amount of the conductive agent may be 0.1 weight % or more and 30 weight % or less based on the total weight of the negative electrode active material layer. The amount of the conductive agent may be preferably 0.5 weight % or more and 15 weight % or less, and more preferably 0.5 weight % or more and 10 weight % or less. When the amount of the conductive agent satisfies the above-described range, it is possible to impart sufficient conductivity, and since there is no reduction in the amount of the negative electrode active material, it is possible to ensure the battery capacity.

(Thickening Agent)

The negative electrode active material slurry may further comprise a thickening agent. Specifically, the thickening agent may be a cellulose-based compound, for example, carboxymethyl cellulose (CMC). For example, the thickening agent may be included in an amount of 0.5 mass % or more and 10 mass % or less based on the total weight of the negative electrode active material layer.

(Solvent)

The solvent used in the negative electrode active material slurry includes, without limitation, any type of solvent commonly used to manufacture the negative electrode. Examples of the solvent may include at least one of N-methyl-2-pyrrolidone (NMP), dimethylsulfoxide (DMSO), isopropyl alcohol, acetone or water, but is not limited thereto.

[Method for Manufacturing Negative Electrode]

The method for manufacturing a negative electrode for a lithium ion secondary battery according to an embodiment may include (1) the step of obtaining a negative electrode active material; (2) the step of obtaining a negative electrode active material slurry from the negative electrode active material; and (3) the step of obtaining a negative electrode from the negative electrode active material slurry.

(1) Step of Obtaining Negative Electrode Active Material

The first silicon oxide powder A may be obtained by, for example, thermal doping. More specifically, the first silicon oxide powder A may be obtained by, for example, mixing silicon oxide powder as a raw material and doping metal source powder, and high temperature sintering in an inert atmosphere such as an argon atmosphere or a nitrogen atmosphere. If necessary, the obtained first silicon oxide powder A may be milled by a bead mill to adjust the particle size.

For example, commercially available SiOₓ (0<x<2) powder may be used as the silicon oxide powder as the raw material. Here, a ratio x of oxygen to silicon is 0<x<2, preferably 0.5≤x≤1.6, and more preferably 0.8≤x≤1.5. Examples of the doping metal source may include metal lithium (Li) or lithium hydride (LiH) in the case of doping with lithium, and in the case of doping with magnesium, may include magnesium hydride (MgH₂), and in the case of doping with calcium, may include calcium hydride (CaH₂), but is not limited thereto. The sintering temperature is, for example, 650° C. or more and 850° C. or less.

For example, commercially available SiOₓ (0<x<2) may be used as the second silicon oxide powder B. The SiOₓ powder used may be the same as or different from the SiOₓ powder used as the raw material of the first silicon oxide powder A. If necessary, the second silicon oxide powder B may be milled by a bead mill to adjust the particle size. The first silicon oxide powder A and the second silicon oxide powder B may be mixed with any other material, for example, a carbon material, if necessary, to obtain a negative electrode active material.

(2) Step of Obtaining Negative Electrode Active Material Slurry from Negative Electrode Active Material

The solvent is added to the negative electrode active material obtained in the above step (1). In this instance, the conductive agent, the binder and the thickening agent may be added if necessary. The negative electrode active material slurry may be obtained by dissolving or dispersing the negative electrode active material, the conductive agent, the binder and the thickening agent in the solvent.

(3) Step of Obtaining Negative Electrode from Negative Electrode Active Material Slurry

The negative electrode active material slurry may be coated on the negative electrode current collector, dried and roll pressed to manufacture the negative electrode having the negative electrode active material layer on the negative electrode current collector.

Alternatively, for example, the negative electrode may be manufactured by casting the negative electrode active material slurry on a support, and laminating a film separated from the support on the negative electrode current collector. Additionally, the negative electrode active material layer may be formed on the negative electrode current collector by any other method.

[Positive Electrode]

In the lithium ion secondary battery according to an embodiment, the positive electrode comprises a positive electrode current collector and a positive electrode active material layer formed on one or two surfaces of the positive electrode current collector. The positive electrode active material layer may be formed on part or entirety of the surface of the positive electrode current collector.

(Positive Electrode Current Collector)

The positive electrode current collector used in the positive electrode includes, without limitation, any type of positive electrode current collector that has conductivity while not causing a chemical change to the battery. For example, the positive electrode current collector may include stainless steel; aluminum; nickel; titanium; sintered carbon; aluminum or stainless steel treated with carbon, nickel, titanium and silver on the surface.

The positive electrode current collector may be 3 μm or more and 500 μm or less in thickness. The positive electrode current collector may have fine texture on the surface to improve the adhesion with the positive electrode active material. The positive electrode current collector may have a variety of forms, for example, a film, a sheet, a foil, a net, a porous body, a foam and a nonwoven fabric.

(Positive Electrode Active Material Layer)

The positive electrode active material layer may be formed by, for example, coating a positive electrode active material slurry comprising a mixture of a positive electrode active material, a conductive agent and a binder dissolved or dispersed in a solvent on the positive electrode current collector, drying and roll pressing. The mixture may further comprise a dispersing agent, a filler or any other additive if necessary.

The positive electrode active material may be included in an amount of 80 weight % or more and 99 weight % or less based on the total weight of the positive electrode active material layer.

(Positive Electrode Active Material)

The positive electrode active material may include a compound capable of reversible intercalation and deintercalation of lithium. Specific examples may include, for example, lithium metal composition oxide comprising at least one type of metal of cobalt, manganese, nickel, copper, vanadium or aluminum, and lithium. More specifically, the lithium metal composition oxide may include lithium-manganese-based oxide (for example, LiMnO₂, LiMnO₃, LiMn₂O₃, LiMn₂O₄); lithium-cobalt-based oxide (for example, LiCoO₂); lithium-nickel-based oxide (for example, LiNiO₂); lithium-copper-based oxide (for example, Li₂CuO₂); lithium-vanadium-based oxide (for example, LiV₃O₈); lithium-nickel-manganese-based oxide (for example, LiNi_{1-z}Mn_{z}O₂ (0<z<1), LiMn_{2-z}Ni_{z}O₄ (0<z<2)); lithium-nickel-cobalt-based oxide (for example, LiN_{11-y}Co_{y}O₂ (0<y<1)); lithium-manganese-cobalt-based oxide (for example, LiCo_{1-z}Mn_{z}O₂(0<z<1), LiMn_{2-y}Co_{y}O₄ (0<y<2)); lithium-nickel-manganese-cobalt-based oxide (for example, Li(NiₓCo_{y}Mn_{z})O₂ (0<x<1, 0<y<1, 0<z<1, x+y+z=1), Li(NiₓCo_{y}Mn_{z})O₄ (0<x<2, 0<y<2, 0<z<2, x+y+z=2)); lithium-nickel-cobalt-metal (M) oxide (for example, Li(NiₓCo_{y}Mn_{z}M_{w})O₂ (M is selected from the group consisting of Al, Fe, V, Cr, Ti, Ta, Mg and Mo, 0<x<1, 0<y<1, 0<z<1, 0<w<1, x+y+z+w=1)); a compound with partial substitution of at least one other metal element for the transition metal element in the above-described compound. The positive electrode active material layer may comprise at least one of them. However, the positive electrode active material layer is not limited thereto.

In particular, in terms of improvement in the capacity characteristics and stability of the battery, LiCoO₂, LiMnO₂, LiMn₂O₄, LiNiO₂, lithium nickel manganese cobalt oxide (for example, Li(Ni_{1/3}Mn_{1/3}Co_{1/3})O₂, Li(Ni_{0.6}Mn_{0.2}Co_{0.2})O₂, Li(Ni_{0.4}Mn_{0.3}Co_{0.3})O₂, Li(Ni_{0.5}Mn_{0.3}Co_{0.2})O₂, Li(Ni_{0.7}Mn_{0.15}Co_{0.15})O₂, Li(Ni_{0.8}Mn_{0.1}Co_{0.1})O₂), lithium nickel cobalt aluminum oxide (for example, Li(Ni_{0.8}Co_{0.15}Al_{0.05})O₂) are desirable.

(Binder and Conductive Agent)

The type and amount of the binder and the conductive agent used in the positive electrode active material slurry may be the same as the above-described description of the negative electrode.

(Solvent)

The solvent used in the positive electrode active material slurry includes, without limitation, any type of solvent commonly used to manufacture the positive electrode. Examples of the solvent may include at least one of an amine-based solvent such as N,N-dimethyl amino propyl amine, diethylene triamine, N,N-dimethyl formamide (DMF), an ether-based solvent such as tetrahydrofuran, a ketone-based solvent such as methyl ethyl ketone, an ester-based solvent such as methyl acetate, an amide-based solvent such as dimethylaceteamide, 1-methyl-2-pyrrolidone (NMP) or dimethylsulfoxide (DMSO), but is not limited thereto.

The solvent is used in a sufficiently large amount to be viscous enough to dissolve or disperse the positive electrode active material, the conductive material and the binder, and ensure high thickness uniformity when coating on the positive electrode current collector, considering the coating thickness of the slurry or the yield.

[Method for Manufacturing Positive Electrode]

The method for manufacturing a positive electrode for a lithium ion secondary battery according to an embodiment may comprise the step of dissolving or dispersing the positive electrode active material, and optionally, the binder, the conductive agent and the thickening agent in the solvent to obtain the positive electrode active material slurry, and the step of obtaining the positive electrode by coating the positive electrode active material slurry on the positive electrode current collector to form the positive electrode active material layer on the positive electrode current collector in the same way as the method for manufacturing a negative electrode.

[Separator]

In the lithium ion secondary battery according to an embodiment, the separator separates the negative electrode and the positive electrode to provide a channel of movement of a lithium ion, and may include, without limitation, any type of separator commonly used as separators of lithium ion secondary batteries. In particular, the separate preferably has low resistance to the ion movement of the electrolyte and high wettability of the electrolyte. For example, the separator may include a porous polymer film made of polyolefin-based polymer such as ethylene homopolymer, propylene homopolymer, ethylene/butene copolymer, ethylene/hexene copolymer, ethylene/methacrylate copolymer or a stack structure of two or more layers of them. Additionally, a commonly used porous nonwoven fabric, for example, a nonwoven fabric made of high melting point glass fibers or polyethylene terephthalate fibers may be used. Additionally, to ensure heat resistance or mechanical strength, the separator may be coated with ceramics or a polymer material. [Nonaqueous Electrolyte]

In the nonaqueous electrolyte secondary battery according to an embodiment, the nonaqueous electrolyte may include an organic liquid electrolyte and an inorganic liquid electrolyte used to manufacture secondary batteries, but is not limited thereto.

The nonaqueous electrolyte may comprise an organic solvent and a lithium salt, and if necessary, may further comprise an additive. Hereinafter, the liquid electrolyte is referred to as an ‘electrolyte solution’.

The organic solvent includes, without limitation, any type of organic solvent serving as a medium that allows the movement of an ion involved in the electrochemical reaction of the battery. Examples of the organic solvent may include at least one of an ester-based solvent such as methyl acetate, ethyl acetate, γ-butyrolactone, ε-caprolactone; an ether-based solvent such as dibutyl ether, tetrahydrofuran; a ketone-based solvent such as cyclohexanone; an aromatic hydrocarbon-based solvent such as benzene, fluoro benzene; a carbonate-based solvent such as dimethyl carbonate (DMC), diethyl carbonate (DEC), methyl ethyl carbonate (MEC), ethyl methyl carbonate (EMC), ethylene carbonate (EC), propylene carbonate (PC); an alcohol-based solvent such as ethyl alcohol, isopropyl alcohol; a nitrile-based solvent such as R—CN (R is a hydrocarbon group with C2 to C20 having a straight chain, branched or cyclic structure, and may comprise a double-bond aromatic ring or ether bond); an amide-based solvent such as dimethyl formamide; a dioxolane-based solvent such as 1,3-dioxolane; or a sulfolane-based solvent, but are not limited thereto. In particular, the carbonate-based solvent is desirable, and a mixture of cyclic carbonate (for example, ethylene carbonate or propylene carbonate) having high ionic conductivity and a high dielectric constant to improve the charge/discharge performance of the battery and a low viscosity straight-chain carbonate-based compound (for example, ethyl methyl carbonate, dimethyl carbonate, diethyl carbonate) are more desirable. In this case, the mixture of cyclic carbonate and straight-chain carbonate at a volume ratio of about 1:1 to 1:9 may provide the outstanding electrolyte performance.

The lithium salt may include, without limitation, any type of compound capable of providing a lithium ion used in the lithium ion secondary battery. Examples of the lithium salt may include at least one of LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI or LiB(C₂O₄)₂, but is not limited thereto. For example, the lithium salt may be included in the electrolyte at the concentration of 0.1 mol/L or more and 2 mol/L or less. When the concentration of the lithium salt is included in the above-described range, the electrolyte has an appropriate conductivity and viscosity, and thus exhibits the outstanding electrolyte performance, thereby achieving the effective movement of a lithium ion.

The additive may be used, where necessary, to improve the life characteristics of the battery, prevent the battery capacity reduction and improve the battery discharge capacity. Examples of the additive may include at least one of a haloalkylene carbonate-based compound such as fluoro ethylene carbonate (FEC) or difluoro ethylene carbonate (DFEC), pyridine, triethyl phosphite, triethanol amine, cyclic ether, ethylene diamine, n-glyme, hexaphosphoric acid triamide, nitrobenzene derivatives, sulfur, quinone imine dye, N-substituted oxazolidinone, N,N-substituted imidazolidine, ethyleneglycol dialkylether, an ammonium salt, pyrrole, 2-methoxy ethanol or aluminum trichloride, but are not limited thereto. For example, the additive may be included in an amount of 0.1 weight % or more and 15 weight % or less based on the total weight of the electrolyte.

In particular, fluoro ethylene carbonate and difluoro ethylene carbonate may acts as a film forming agent to form a film in the electrode-electrolyte interface. For example, when at least one of fluoro ethylene carbonate or difluoro ethylene carbonate is included, a good SEI layer may be formed during the alloying of the silicon-based material and lithium in the negative electrode using the negative electrode active material comprising the silicon-based material, resulting in stable charging/discharging. The film forming agent may be included in an amount of, for example, 0.1 weight % or more and 15 weight % or less, preferably 0.5 weight % or more and 10 weight % or less, and more preferably 1 weight % or more and 7 weight % or less based on the total weight of the electrolyte. The film forming agent may comprise at least one of fluoro ethylene carbonate or difluoro ethylene carbonate.

[Method for Manufacturing Nonaqueous Electrolyte Secondary Battery]

The nonaqueous electrolyte secondary battery according to an embodiment may be manufactured by placing the separator and the electrolyte solution between the negative electrode manufactured as described above and the positive electrode manufactured as described above. More specifically, the nonaqueous electrolyte secondary battery may be manufactured by placing the separator between the negative electrode and the positive electrode to form an electrode assembly, putting the electrode assembly in a battery case, for example, a cylindrical battery case or a prismatic battery case, and injecting the electrolyte. Alternatively, the nonaqueous electrolyte secondary battery may be manufactured by putting a result of stacking the electrode assembly and wetting in the electrolyte in the battery case, which in turn, may be sealed.

Those commonly used in the art may be employed as the battery case. The shape of the battery case may be, for example, a cylindrical, prismatic, pouch or coin shape using a can.

The lithium ion secondary battery according to an embodiment may be used as a power source of a small device as well as a unit battery of a medium to large battery module comprising battery cells. Preferred examples of the medium to large device may include an electric vehicle, a hybrid electric vehicle, a plug-in hybrid electric vehicle and an energy storage system, but are not limited thereto.

### EXAMPLE

Hereinafter, examples and comparative examples will be described, but the present disclosure is not limited thereto. Additionally, the mechanism described below is simply an exemplary presumption for helping the understanding of the present disclosure, and does not intend to limit the present disclosure.

### Example 1

(Manufacture of Negative Electrode)

Amorphous SiO powder is doped with lithium by thermal doping to prepare silicon oxide powder (first silicon oxide powder A). The average particle size of particles that make up the first silicon oxide powder A is 7.0 μm. The lithium content measured by inductively coupled plasma spectroscopy is 6 weight % based on the total weight of the first silicon oxide powder A. As a result of X-ray diffraction (XRD) measurement of the first silicon oxide powder A, a diffraction peak of the (111) plane of silicon (Si) is observed near 2θ=28.4°. The crystallite size of the silicon microcrystal calculated from the (111) peak using the Scherrer formula is about 9 nm. Besides, peaks originating from Li₂SiO₃ and Li₂Si₂O₅ are observed on the XRD pattern.

Amorphous SiO powder (Sigma Aldrich) is milled by a bead mill to prepare undoped silicon oxide powder (second silicon oxide powder B). The average particle size of particles that make up the second silicon oxide powder B is 1.6 μm, the lower limit of the particle size distribution is 0.3 μm, and the upper limit of the particle size distribution is 6.0 μm. As a result of measuring the XRD pattern of the second silicon oxide powder B, a diffraction peak showing a crystalline phase is not observed.

The first silicon oxide powder A and the second silicon oxide powder B are mixed at a weight ratio of 5:5 to obtain negative electrode active material powder. 5 parts of weight of carbon black as a conductive agent, 10 parts of weight of poly acrylate as a binder are added to 85 parts of weight of negative electrode active material powder, and pure water as a solvent is added and mixed to obtain a negative electrode active material slurry. The negative electrode active material slurry is coated on a copper foil and dried in a vacuum, and then pressed to a predetermined density to obtain a negative electrode.

(Manufacture of Battery)

A coin battery (a half cell) is manufactured using metal lithium as the counter electrode (i.e., the positive electrode) of the obtained negative electrode.

### Example 2

A coin battery is manufactured in the same way as example 1 except that the weight ratio of the first silicon oxide powder A and the second silicon oxide powder B is 8:2.

### Example 3

In the same way as example 1, the first silicon oxide powder A and the second silicon oxide powder B are mixed at a weight ratio of 5:5 to obtain mixed powder. Natural graphite is added to the mixed powder such that a weight ratio of the mixed powder and the natural graphite is 1:9 and mixed to obtain negative electrode active material powder (i.e., the weight ratio of the first silicon oxide powder A, the second silicon oxide powder B and the natural graphite is 0.5:0.5:9). 1.0 part of weight of carbon black as a conductive agent and 1.5 parts of weight of styrene butadiene rubber (SBR) as a binder and 1.5 parts of weight of carboxymethyl cellulose (CMC) as a thickening agent are added to 96 parts of weight of the negative electrode active material powder, and pure water as a solvent is added and mixed to obtain a negative electrode active material slurry. The negative electrode active material slurry is coated on a copper foil and dried in a vacuum, and then pressed to a predetermined density to obtain a negative electrode. A coin battery is manufactured using metal lithium as the counter electrode (i.e., the positive electrode) of the negative electrode.

### Example 4

A coin battery is manufactured in the same way as example 1 except that the average particle size of the first silicon oxide powder A is adjusted to 4.2 μm.

### Example 5

A coin battery is manufactured in the same way as example 1 except that the average particle size of the second silicon oxide powder B is adjusted to 0.8 μm.

### Comparative Example 1

A coin battery is manufactured in the same way as example 1 except that the second silicon oxide powder B is not used and only the first silicon oxide powder A is used (i.e., the weight ratio of the first silicon oxide powder A and the second silicon oxide powder B is 10:0).

### Comparative Example 2

A coin battery is manufactured in the same way as example 1 except that the first silicon oxide powder A is not used and only the second silicon oxide powder B is used (i.e., the weight ratio of the first silicon oxide powder A and the second silicon oxide powder B is 0:10).

### Comparative Example 3

A coin battery is manufactured in the same way as example 3 except that the second silicon oxide powder B is not used and only the first silicon oxide powder A is mixed with natural graphite (i.e., the weight ratio of the first silicon oxide powder A, the second silicon oxide powder B and the natural graphite is 1:0:9).

### Comparative Example 4

A coin battery is manufactured in the same way as example 3 except that the first silicon oxide powder A is not used and only the second silicon oxide powder B is mixed with natural graphite (i.e., the weight ratio of the first silicon oxide powder A, the second silicon oxide powder B and the natural graphite is 0:1:9).

### Comparative Example 5

A coin battery is manufactured in the same way as example 1 except that the average particle size of the first silicon oxide powder A is adjusted to 18 μm.

### Comparative Example 6

A coin battery is manufactured in the same way as example 1 except that the average particle size of the second silicon oxide powder B is adjusted to 5 μm.

### Evaluation Example 1

### Initial Charge/Discharge Characteristics

The coin battery manufactured by each example and each comparative example is charged/discharged at the constant current of 0.2 C with the cutoff voltage of 1.5V. The ‘initial capacity’ is a value obtained by dividing the discharge capacity during the initial charge/discharge by the weight (g) of the negative electrode active material powder used in each example and each comparative example, and is defined as below:

$$Initial Capacity ( mAh / g ) = \frac{First cycle discharge capacity ( mAH )}{Weight of negative electrode active mateiral powder ( g )} \qquad [ Equation 1 ]$$

Additionally, the charge/discharge efficiency during the initial charge/discharge (hereinafter referred to as ‘initial efficiency’) is defined as the following equation:

$$Initial Efficiency ( \% ) = \frac{First cycle discharge capacity}{First cycle charge capacity} ⨯ 100 \% \qquad [ Equation 2 ]$$

### Evaluation Example 2

### Capacity Retention

After the initial charge/discharge performed in evaluation example 1, the coin battery manufactured by each example and each comparative example is charged/discharged once more in the same condition, and then charging/discharging is repeated 48 more cycles at the constant current of 0.5 C. That is, charging/discharging is repeated a total of 50 cycles including the first and second charge/discharge cycles. The capacity retention during the repeated charge/discharge is defined as the following equation:

$$Capacity Retention ( \% ) = \frac{50 th cycle discharge capacity}{3 rd cycle discharge capacity} ⨯ 100 \% \qquad [ Equation 3 ]$$

The initial capacity, the initial efficiency and the capacity retention calculated for each coin battery manufactured by each example and each comparative example are as follows. Meanwhile, the following table also shows the weight ratio of the first silicon oxide powder A and the second silicon oxide powder B (‘A:B’ and ‘B/A’) and the weight ratio of silicon oxide powder and natural graphite (‘silicon oxide:graphite’).

TABLE 1

| | Average | Average | | | | | | |
|---|---|---|---|---|---|---|---|---|
| | particle size | particle size | | | | Initial | Initial | Capacity |
| | of particle | of particle | | | Silicon | capacity | efficiency | retention |
| | A (μm) | B (μm) | A:B | B/A | oxide:graphite | (mAh/g) | (%) | (%) |
| Example 1 | 7.0 | 1.6 | 5:5 | 1 | 10:0 | 1574 | 82.7 | 95.6 |
| Example 2 | 7.0 | 1.6 | 8:2 | 0.25 | 10:0 | 1440 | 87.5 | 83.5 |
| Example 3 | 7.0 | 1.6 | 5:5 | 1 | 1:9 | 486 | 91.0 | 99.1 |
| Example 4 | 4.2 | 1.6 | 5:5 | 1 | 10:0 | 1571 | 81.6 | 96.1 |
| Example 5 | 7.0 | 0.8 | 5:5 | 1 | 10:0 | 1550 | 80.5 | 95.5 |
| Comparative | 7.0 | — | 10:0 | 0 | 10:0 | 1355 | 91.8 | 71.3 |
| example 1 | | | | | | | | |
| Comparative | — | 1.6 | 0:10 | — | 10:0 | 1774 | 75.4 | 98.5 |
| example 2 | | | | | | | | |
| Comparative | 7.0 | — | 10:0 | 0 | 1:9 | 464 | 93.3 | 92.7 |
| example 3 | | | | | | | | |
| Comparative | — | 1.6 | 0:10 | — | 1:9 | 505 | 86.9 | 99.8 |
| example 4 | | | | | | | | |
| Comparative | 18.0 | 1.6 | 5:5 | 1 | 10:0 | 1421 | 75.0 | 55.3 |
| example 5 | | | | | | | | |
| Comparative | 7.0 | 5.0 | 5:5 | 1 | 10:0 | 1566 | 82.1 | 70.0 |
| example 6 | | | | | | | | |

First, examples 1 and 2 and comparative examples 1 and 2 using no natural graphite are compared. The initial capacity is the lowest (1355 mAh/g) in comparative example 1 using the first silicon oxide powder A alone, and as the ratio of the second silicon oxide powder B to the first silicon oxide powder A increases, the initial capacity increases. Meanwhile, the initial efficiency is the lowest (75.4%) in comparative example 2 using the second silicon oxide powder B alone, and as the ratio of the second silicon oxide powder B to the first silicon oxide powder A decreases, the initial efficiency increases. Additionally, in the same way as the initial capacity, the capacity retention is the lowest (71.3%) in comparative example 1 using the first silicon oxide powder A alone, and as the ratio of the second silicon oxide powder B to the first silicon oxide powder A increases, the capacity retention increases.

Comparative example 1 using the first silicon oxide powder A alone has high initial efficiency but low initial capacity and capacity retention. Additionally, comparative example 2 using the second silicon oxide powder B alone has high initial capacity and capacity retention, but low initial efficiency. By this reason, comparative examples 1 and 2 using either the first silicon oxide powder A or the second silicon oxide powder B fail to achieve high initial efficiency and the outstanding discharge capacity and capacity retention together.

In examples 1 and 2 comprising the first silicon oxide powder A and the second silicon oxide powder B, any one of initial capacity, initial efficiency and capacity retention is not too bad, and thus it is possible to achieve high initial efficiency and the outstanding discharge capacity and capacity retention in balance.

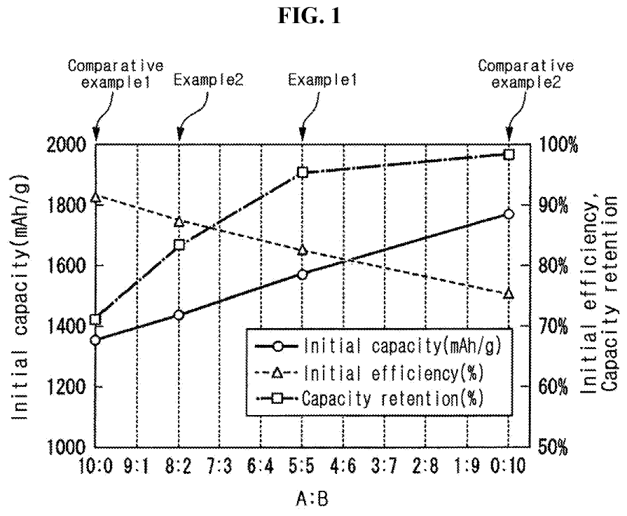

FIG. 1 is a diagram plotting the initial capacity (∘), the initial efficiency (Δ) and the capacity retention (□) as a function of the weight ratio (A:B) of the first silicon oxide powder A and the second silicon oxide powder B in examples 1 and 2 and comparative examples 1 and 2 not using natural graphite. As shown in FIG. 1, the graphs of initial capacity (∘) and initial efficiency (Δ) as a function of A:B are almost linear. That is, the initial capacity increases almost linearly as A:B changes from 10:0 to 0:10, and the initial efficiency decreases almost linearly as A:B changes from 10:0 to 0:10. On the other hand, the graph (□) of capacity retention as a function of A:B does not show a simple proportional relationship, and is a curve that bends upward. That is, when the first silicon oxide powder A is mixed with the second silicon oxide powder B even in a small amount, the capacity retention is dramatically improved from comparative example 1 using the first silicon oxide powder A alone as the negative electrode active material. For example, although the first silicon oxide powder A that may cause cycle degradation occupies half of the negative electrode active material, example 1 having the weight ratio A:B of 5:5 shows the capacity retention of 96% that is much higher than the capacity retention (71%) of comparative example 1 using the first silicon oxide powder A alone as the negative electrode active material. The results reveal that when the first silicon oxide powder A and the second silicon oxide powder B are mixed, the capacity retention is improved beyond expectation by a synergistic effect.

For example, the mechanism of the synergistic effect is explained as follows. However, the following description is only an exemplary presumption for helping the understanding of the present disclosure, and does not intend to limit the present disclosure.

In each example, the first silicon oxide powder A and the second silicon oxide powder B are mixed. The undoped second silicon oxide powder B is likely to accomplish fast lithium intercalation and alloying due to its high ability to intercalate lithium, compared the lithium-doped first silicon oxide powder A. Presumably, the alloying reduces the resistance of the second silicon oxide powder B, and lithium smoothly diffuses from the second silicon oxide powder B to the adjacent first silicon oxide powder A. Accordingly, the surface resistance of the first silicon oxide powder A substantially reduces, and the charging/discharging process is smoothly performed, contributing to the improved life characteristics.

Additionally, when the average particle size of particles that make up the second silicon oxide powder B is smaller than the average particle size of particles that make up the first silicon oxide powder A, the smaller second silicon oxide powder B may be easily placed in the larger first silicon oxide powder A. Accordingly, the total density of the negative electrode active material and further the charge/discharge capacity per weight may increase. Additionally, presumably, the substantial contact area of the first silicon oxide powder A and the second silicon oxide powder B increases, and lithium diffusion, i.e., the charge/discharge of the battery is more smooth, thereby improving the life characteristics.

Subsequently, example 3 and comparative examples 3 and 4 using natural graphite are compared. In the same way as the non-use of natural graphite, the initial capacity and the capacity retention are the lowest in comparative example 3 using the first silicon oxide powder A alone (464 mAh/g, 92.7%), and as the ratio of the second silicon oxide powder B to the first silicon oxide powder A increases, the initial capacity and the capacity retention increase. Meanwhile, the initial efficiency is the lowest in comparative example 4 using the second silicon oxide powder B alone (86.9%), and as the ratio of the second silicon oxide powder B to the first silicon oxide powder A decreases, the initial efficiency increases.

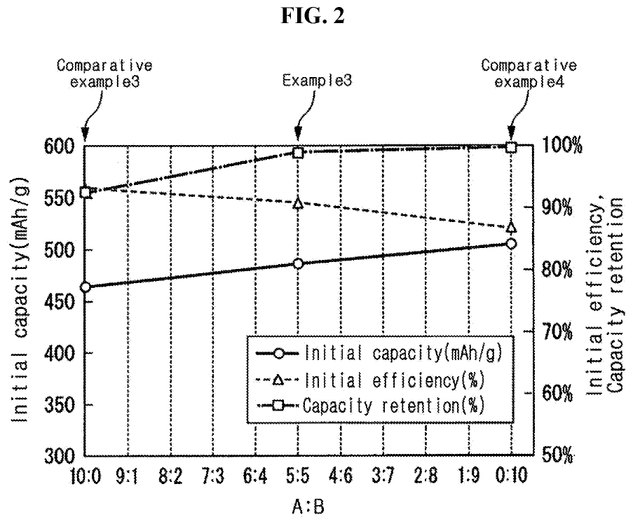

FIG. 2 is a diagram plotting the initial capacity (∘), the initial efficiency (Δ) and the capacity retention (□) as a function of a weight ratio (A:B) of the first silicon oxide powder A and the second silicon oxide powder B in the same way as FIG. 1, in example 3 and comparative examples 3 and 4 using natural graphite. In the same way as the non-use of natural graphite, the graph of initial capacity (∘) as a function of A:B is almost linear. That is, the initial capacity increases almost linearly as A:B changes from 10:0 to 0:10. Meanwhile, in the same way as the non-use of natural graphite, the graph of capacity retention (□) as a function of A:B does not show a simple proportional relationship and is a curve that bends upward. That is, by the addition of the second silicon oxide powder B, the capacity retention is dramatically improved from comparative example 3 using the first silicon oxide powder A alone as the negative electrode active material. Accordingly, also in case that natural graphite is used, there is an improvement in the capacity retention beyond expectation when the first silicon oxide powder A and the second silicon oxide powder B are mixed.

Additionally, as opposed to the non-use of natural graphite, the graph of initial efficiency (Δ) as a function of A:B does not show a simple proportional relationship, and is a curve that bends upward. That is, although the second silicon oxide powder B is added to the first silicon oxide powder A, the initial efficiency does not linearly reduce and reduces more gently as a function of A:B. In other words, by the addition of the first silicon oxide powder A to the second silicon oxide powder B, the initial efficiency is dramatically improved from comparative example 4 using the second silicon oxide powder B alone as the negative electrode active material. The results reveal that a synergistic effect works by mixing the first silicon oxide powder A and the second silicon oxide powder B in the presence of the carbon material, thereby achieving initial efficiency beyond expectation.

The mechanism of the synergistic effect in the presence of the carbon material is explained as follows. However, the following description is only an exemplary presumption for helping the understanding of the present disclosure, and does not intend to limit the present disclosure.

It is presumed that high initial efficiency is obtained by the addition of the carbon material since when the carbon material such as graphite having a small volume change caused by the charge/discharge compared to silicon oxide is mixed, a volume change of the electrode during the first cycle charge involving a largest change caused by charging is smaller than that when silicon oxide alone is used as the negative electrode active material. Additionally, the improved capacity retention results from easy-to-deform and high electronic conductivity of the carbon material. That is, silicon oxide is rigid, and does not deform when the electrode is pressed, so when the negative electrode active material consists of silicon oxide, even though the first silicon oxide powder A and the second silicon oxide powder B having a difference in particle size are mixed, voids that may disconnect the conducting path are easily formed in some regions of the electrode. Presumably, when graphite, in particular, natural graphite, which is soft and easily deforms by a press is mixed, such voids significantly reduce. Additionally, presumably, since natural graphite having high electronic conductivity comes into close contact with silicon oxide having relatively low electronic conductivity, natural graphite helps the improved intercalation. deintercalation of a lithium ion to/from silicon oxide. By this reason, it is presumed that the addition of the carbon material improves the first cycle charge as well as the life characteristics, i.e., the capacity retention.

Meanwhile, examples 1 and 2 and comparative examples 1 and 2 not using natural graphite and example 3 and comparative examples 3 and 4 using natural graphite differ in the type of the binder and the thickening agent used, but simply an appropriate binder and thickening agent are selected according to whether natural graphite is used or not. This difference does not greatly affect the initial capacity, the initial efficiency and the capacity retention of the battery.

Also in the case of examples 4 and 5, compared to example 1, the initial efficiency is somewhat low with the decreasing particle size of each of A and B, but in the same way as example 1, the initial capacity and the life (capacity retention) are found good. Meanwhile, as in comparative example 5, when the particle size of A increases, electrode destruction caused by expansion occurs from the first cycle charge/discharge, and thus even though B is added, a conducting path between particles cannot be obtained and the life characteristics significantly degrade. Additionally, as in comparative example 6, when the particle size of B increases, it is very difficult to uniformly fill the voids between particles, and due to the expansion of B itself, electrode degradation is severer than example 1, resulting in life degradation.

1. A negative electrode active material for a secondary battery, comprising:
first silicon oxide powder particles doped with at least one of an alkali metal or an alkaline earth metal, and
second silicon oxide powder particles, which are not doped.
wherein the second silicon oxide powder particles are amorphous,
wherein an average particle size of the first silicon oxide powder particles is larger than an average particle size of the second silicon oxide powder particles, and
wherein the average particle size of the first silicon oxide powder particles is 3 μm or more and 15 μm or less, and the average particle size of the second silicon oxide powder particles is 0.5 μm or more and 2 μm or less.

2. The negative electrode active material according to claim 1, wherein a weight ratio of the second silicon oxide powder particles to the first silicon oxide powder particles is equal to or greater than 0.2.

3. The negative electrode active material according to claim 1, wherein a weight ratio of the second silicon oxide powder particles to the first silicon oxide powder particles is less than 10.

4. The negative electrode active material according to claim 1, wherein the first silicon oxide powder particles comprise microcrystals of silicon having a crystallite size of 5 nm or more and 30 nm or less.

5. The negative electrode active material according to claim 1, wherein the first silicon oxide powder particles comprise at least one of Li₂SiO₃, Li₂ Si₂O₅, Li₄SiO₄ or Mg₂SiO₄.

6. The negative electrode active material according to claim 1, further comprising a carbon material powder comprising at least one of natural graphite, artificial graphite, a graphitized carbon fiber or amorphous carbon.

7. A negative electrode for a secondary battery, comprising:
a negative electrode active material layer on a negative electrode current collector,
wherein the negative electrode active material layer comprises the negative electrode active material according to claim 1.

8. A secondary battery comprising the negative electrode according to claim 7.

9. The negative electrode active material according to claim 1, wherein the alkali metal or alkaline earth metal comprises at least one of lithium, sodium, potassium, magnesium or calcium.

10. The negative electrode active material according to claim 1, wherein a total doping amount of alkali metal or alkaline earth metal in the first silicon oxide powder particles ranges from 0.1 weight % or more and 20 weight % or less.

11. The negative electrode active material according to claim 1, wherein a total doping amount of alkali metal or alkaline earth metal in the first silicon oxide powder particles ranges from 0.5 weight % or more and 15 weight % or less.

12. The negative electrode active material according to claim 1, wherein the second silicon oxide powder particles consist of SiOₓ, wherein 0<x<2.

13. The negative electrode active material according to claim 1, wherein a weight ratio of the second silicon oxide powder particles to the first silicon oxide powder particles is more than 0.25 and less than 2.
